(19) United States
(12) Patent Application Publication
(10) Pub. No.: US 2014/0304218 A1
(43) Pub. Date: Oct. 9, 2014

(54) AUGMENTING A BUSINESS INTELLIGENCE REPORT WITH A SEARCH RESULT

(71) Applicant: INTERNATIONAL BUSINESS MACHINES CORPORATION, Armonk, NY (US)

(72) Inventors: Billy W. Chang, Rockville, MD (US); Sarbajit K. Rakshit, Kolkata (IN)

(73) Assignee: International Business Machines Corporation, Armonk, NY (US)

(21) Appl. No.: 13/858,966

(22) Filed: Apr. 9, 2013

(51) Int. Cl. G06F 17/30

(52) U.S. Cl. CPC G06F 17/30864
USPC 707/603

(57) ABSTRACT

A computer augments a business intelligence report. The computer populates a business intelligence report with business data imported from business data storage, and with a stored internet search query. The computer causes the display of the business data of the business intelligence report. The computer also transmits one or both of a term of the stored internet search query or of referenced business data of the stored internet search query to a designated search engine, and receives a contemporary search result from the designated search engine. The computer causes the display of the contemporary search result.

### FIELD OF THE INVENTION

The present invention relates generally to the generation of a business intelligence report, and more particularly to the augmentation of a business intelligence report with a search result.

### BACKGROUND

Business intelligence, which has been defined as the ability to apprehend the interrelationships of presented facts in such a way as to guide action towards a desired business goal, includes a set of theories, methodologies, processes, architectures, and technologies that are applied to transform raw data into meaningful and useful information for an enterprise. Such theories, methodologies, processes, architectures, and technologies are implemented in a variety of business intelligence tools, which can typically handle large amounts of information to help identify and develop new business opportunities. The large amounts of information can be generated within the enterprise. Identifying and developing new business opportunities, and implementing an effective strategy, can provide a commercial advantage (for example, a competitive market advantage) and long-term stability to the enterprise.

There are various business intelligence tools available on the market. Some of these available tools allow users within an enterprise to create fixed-format reports with a report designer that includes drag-and-drop interface features. The available tools further allow users to create management reports in various modes, create analyses of large data sources and search for background information about an event or action. Further still, the available tools also allow users to set up notifications using a notification tool that informs them about events within the enterprise in real time.

### SUMMARY

Embodiments of the present invention provide for a program product, system, and method in which a computer augments a business intelligence report. The computer populates a business intelligence report with business data imported from business data storage, and with a stored internet search query. The computer causes the display of the business data of the business intelligence report. The computer also transmits one or both of a term of the stored internet search query or of referenced business data of the stored internet search query to a designated search engine, and receives a contemporary search result from the designated search engine. The computer causes the display of the contemporary search result.

### BRIEF DESCRIPTION OF THE SEVERAL VIEWS OF THE DRAWINGS

FIG. 1 is a block diagram of a business intelligence environment in accordance with an embodiment of the present invention.

FIG. 2 is an illustration of a user interface depicting a business intelligence report view in accordance with an embodiment of the present invention.

FIGS. 3A and 3B are flowcharts depicting steps followed by a report editor and a report viewer during the editing and viewing of a business intelligence report in accordance with an embodiment of the present invention.

FIG. 4 is a block diagram of a computer system in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) Java may be subject to trademark and/or service mark rights in various jurisdictions throughout the world, and, to that extent, references to this term(s) herein are to be taken to exclusively apply only to legitimate products of the trademark / service mark owner(s)), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor (i.e., a computing processor) of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

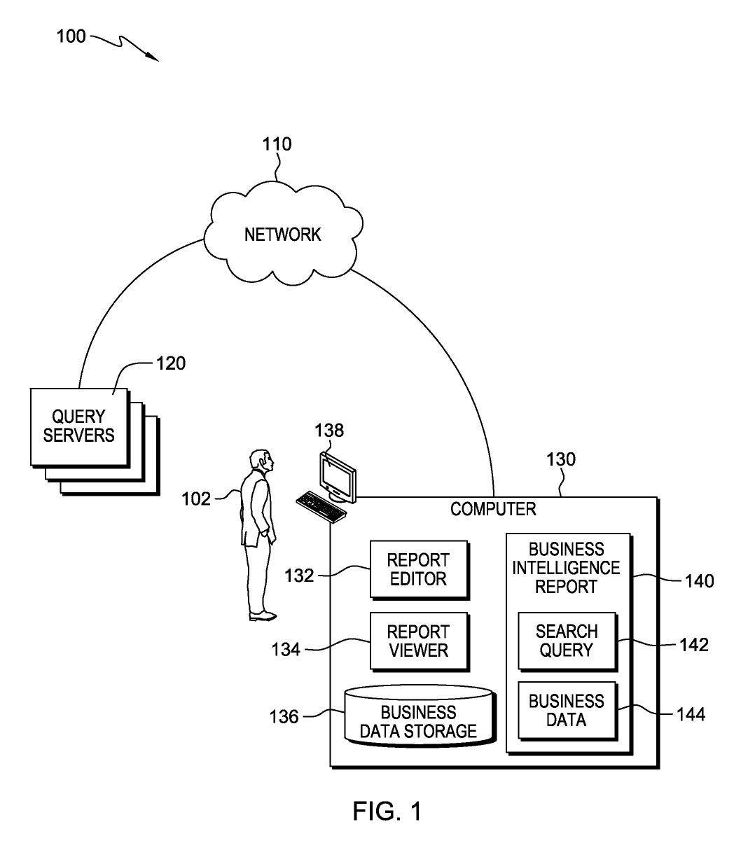

Referring now to FIG. 1, a block diagram of business intelligence environment 100 in accordance with an embodiment of the present invention is shown. Business intelligence environment 100 includes network 110, query servers 120, and computer 130. Network 110 can be, for example, a local area network (LAN), a wide area network (WAN) such as the Internet, or a combination of the two, and can include wired or wireless connections. In general, network 110 can be any combination of connections and protocols that will support communications via various channels between query servers 120 and computer 130 in accordance with an embodiment of the invention. As will be discussed in detail below, person 102, a user in an enterprise of business intelligence environment 100, can utilize computer 130 to edit and view business intelligence report 140, and to display a contemporary search result generated by performing a search based at least in part on a stored internet search query. Some embodiments of the present invention can leverage techniques found in IBM Cognos (note: the terms “IBM” and “Cognos” may be subject to trademark rights in various jurisdictions throughout the world and are used here only in reference to the products or services properly denominated by the marks to the extent that such trademark rights may exist).

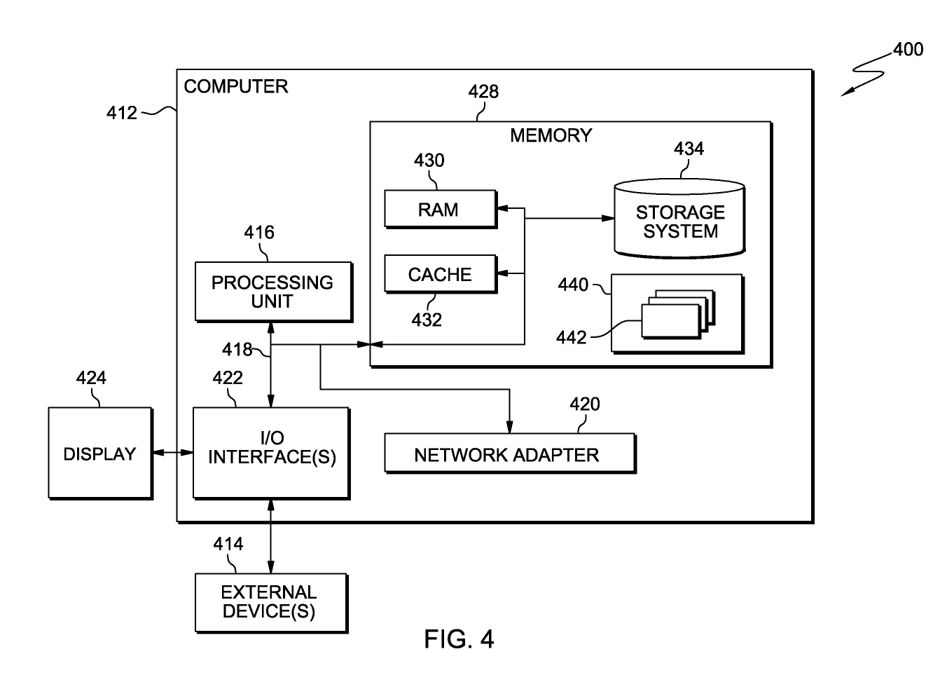

In various embodiments, each one of query servers 120, as well as computer 130, can include a laptop, tablet, or netbook personal computer, a desktop computer, a personal digital assistant, a smart phone, a mainframe computer, or a networked server computer. Further, each one of query servers 120, as well as computer 130, can include computing systems utilizing clustered computers and components to act as single pools of seamless resources when accessed through network 110, or can represent one or more cloud computing datacenters. In general, each one of query servers 120, as well as computer 130, can be any programmable electronic device as described in further detail below with respect to FIG. 4.

Computer 130 includes report editor 132, report viewer 134, business data storage 136, and business intelligence report 140. Report editor 132 and report viewer 134 are programs for the editing and viewing, respectively, of business intelligence report 140. During editing, report editor 132 imports business data 144 to business intelligence report 140 from business data storage 136, and stores search query 142 in business intelligence report 140. During viewing, business intelligence report 140 can be displayed under control of report viewer 134 by displaying imported business data 144 and by displaying a contemporary search result generated by performing a search based at least in part on stored search query 142. User interface 138 includes software, hardware, or both to support editing and viewing of business intelligence report 140 by person 102.

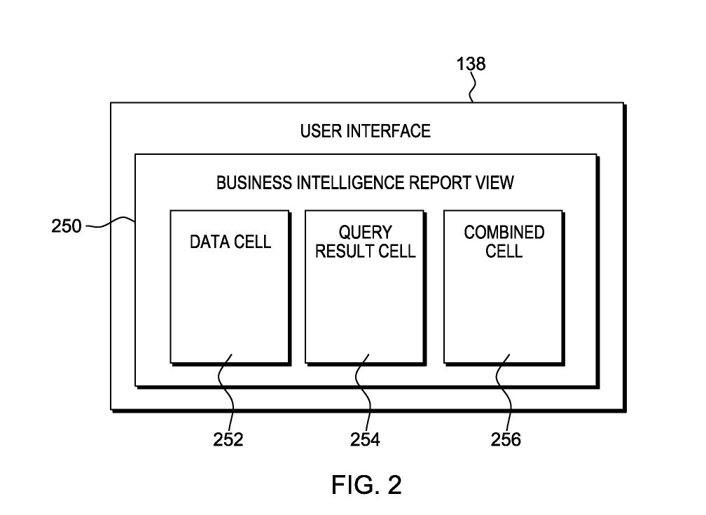

Business intelligence report 140 is a report designed to help its reader apprehend the interrelationships of presented facts in such a way as to guide action towards a desired business goal. In one embodiment, business intelligence report 140 includes one or more cells, not shown in FIG. 1, where each cell is a section, area, or module that includes or presents a particular division of the information presented by business intelligence report 140. For example, one cell in business intelligence report 140 can include or present a chart depicting sales data, while another cell can include or present text related to customer data, while a third cell can include or present a table of inventory data. Business intelligence report 140 can also include search query 142 and business data 144, which can each be associated with one or more cells of business intelligence report 140. Business data 144 is data from business data storage 136 associated with one or more cells of business intelligence report 140, and search query 142 is an internet search query associated with one or more cells of business intelligence report 140. Search query 142 and business data 144 can share an association with a cell of business intelligence report 140, or can be associated with separate cells. Cells of business intelligence report 140 are discussed in more detail below in the context of FIG. 2.

Report editor 132, a program for the editing of business intelligence report 140, can be used, by person 102 via user interface 138, to generate new reports and to edit previously-generated reports. Report editor 132 can display business intelligence report 140 in an editing mode, such that business intelligence report 140 is shown to include one or more editable cells, each of which can be populated with business data 144 imported into business intelligence report 140 from business data storage 136, with stored internet search query 142, or with both.

In particular, report editor 132 can populate an editable cell of business intelligence report 140 with business data 144 imported from business data storage 136. Business data storage 136 can include all manner of data relevant to the enterprise of business intelligence environment 100, and can be implemented as a relational database, for example. Business data storage 136 can include information generated within the enterprise as well as information collected from sources external to the enterprise. For example, business data storage 136 may include data related to the sales of products sold by the enterprise, to the levels of inventory maintained by the enterprise, to the network traffic experienced by computer systems of the enterprise, to the personnel records of employees of the enterprise, to the customer records of customers of the enterprise, or to any other type of data relevant to the enterprise of business intelligence environment 100. In one embodiment, business data 144 imported from business data storage 136 can be included in business intelligence report 140 as a copy, such that a future retrieval from business data storage 136 becomes unnecessary. In another embodiment, business data 144 imported from business data storage 136 can be included in business intelligence report 140 as a link (for example, as a hyperlink, as an SQL query link, etc.), to facilitate retrieval from business data storage 136 of this information during a future viewing.

In one embodiment that facilitates relevant searching at the time business intelligence report 140 is viewed, report editor 132 populates an editable cell of business intelligence report 140 with stored internet search query 142. A stored internet search query can include one or more terms, such as words or phrases, that will be used to perform a search during subsequent viewing of business intelligence report 140. Each term can be supplied by, for example, person 102, and may be joined to additional terms with Boolean operators. The stored internet search query can be any type of query (for example, text based, graphic based, etc.) now known or to be developed in the future using any query language or protocol now known or to be developed in the future. Example internet search queries include “what are the competitors of product X,” “what is the total weekly recommendation from different users on the Internet,” and “what is the negative feedback of the product.” The stored internet search query can further include a designated search engine, such as one or more of query servers 120. Further still, the stored internet search query can also include links to business data 144 associated with one or more cells of business intelligence report 140. Like a term, a link to business data 144 can be used to perform a search during subsequent viewing of business intelligence report 140.

The stored internet search query may be used to query a storehouse of information above and beyond what is available on the internet and/or on the publically available portions of the internet. In other words, while the “internet search query” is designed to search data on the internet (or at least a portion of the internet), the query can also extend to private databases, such as private databases of the enterprise. As such, query servers 120 can include public sources of information and private sources of information.

Report viewer 134, a program for the viewing of business intelligence report 140, can be used by person 102 via user interface 138. A view of business intelligence report 140 will be discussed in more detail below in the context of FIG. 2. During a viewing of business intelligence report 140, business data 144 is displayed in one or more cells of business intelligence report 140. Further, during a viewing of business intelligence report 140, a term of search query 142, or business data 144 associated with a particular cell, referenced by a link of search query 142, can be transmitted to a designated search engine, to yield a contemporary search result to be used during the display of one or more cells of business intelligence report 140. In one embodiment, the search can be performed and the contemporary report yielded when report viewer 134 initially displays a view of business intelligence report 140. In another embodiment, the search can be performed and the contemporary report yielded subsequently, for example during an interaction of person 102 with the view of business intelligence report 140. Further, person 102 may choose to ignore the query; to perform the query “as is” at the time the report is displayed; or to edit the query before performing the search at the time the search is displayed.

FIG. 2 shows an illustration of user interface 138 depicting business intelligence report view 250 in accordance with an embodiment of the present invention. Business intelligence report view 250 is a view of business intelligence report 140, and includes data cell 252, query result cell 254, and combined cell 256. The display of business intelligence report 140 in business intelligence report view 250 is augmented with a contemporary search result, as discussed below. It is noted that business intelligence report view 250 may be only partially generated and/or displayed at the time it is augmented with a contemporary search result, or may be fully generated and/or displayed at the time it is augmented with a contemporary search result.

Data cell 252 is a displayed cell that includes associated business data 144. For example, data cell 252 can include or present a chart depicting sales data, where the sales data was imported to business intelligence report 140 by report editor 132. Business data 144 is associated with data cell 252, and search query 142 is not. As such, not every cell of business intelligence report 140 necessarily need be augmented with a contemporary search result.

Query result cell 254 is a displayed cell that includes a contemporary search result generated by performing a search based at least in part on stored search query 142. For example, query result cell 254 can include or present text related to customer data, where search query 142 was stored in business intelligence report 140 by report editor 132, and where a contemporary search of a customer-relevant term on one or more of query servers 120 yields text related to customer data. For instance, if search query 142 includes the term “buyer opinions of enterprise product X,” then the yielded text can include online reviews about enterprise product X gathered from query servers 120. Search query 142 is associated with query result cell 254, and business data 144 is not.

Combined cell 256 is a displayed cell that includes both associated business data 144 as well as a contemporary search result generated by performing a search based at least in part on stored search query 142. For example, combined cell 256 can include or present a table of inventory data, where a first portion of the inventory data was imported with business data 144 to business intelligence report 140, where search query 142 was stored in business intelligence report 140, and where a contemporary search of an inventory-relevant term on one or more of query servers 120 yields a second portion of the inventory data. In one embodiment, the inventory-relevant term can include the first portion of the inventory data. For instance, if the first portion is a listing of multiple inventory items of business data 144, and if search query 142 includes the term “prices of enterprise inventory item X,” then the yielded second portion can include internet prices for each inventory item X in the listing of multiple inventory items. In another embodiment, the inventory-relevant term can be independent of the first portion of the inventory data. Both search query 142 and business data 144 are associated with combined cell 256.

The contemporary search result of query result cell 254 or of combined cell 256 can remain hidden, in one embodiment, and thus not depicted in business intelligence report view 250, until person 102 performs a user interface event, for example a mouseover event, using a pointing device of user interface 138. In one embodiment the contemporary search result of query result cell 254, or the entirety of query result cell 254, can remain hidden until person 102 performs a mouseover event on an icon or other region of user interface 138. In another embodiment, the contemporary search result of combined cell 256 can remain hidden until person 102 performs a mouseover event on an icon or other region of user interface 138, such that prior to the mouseover event, only the associated business data 144 of combined cell 256 is shown.

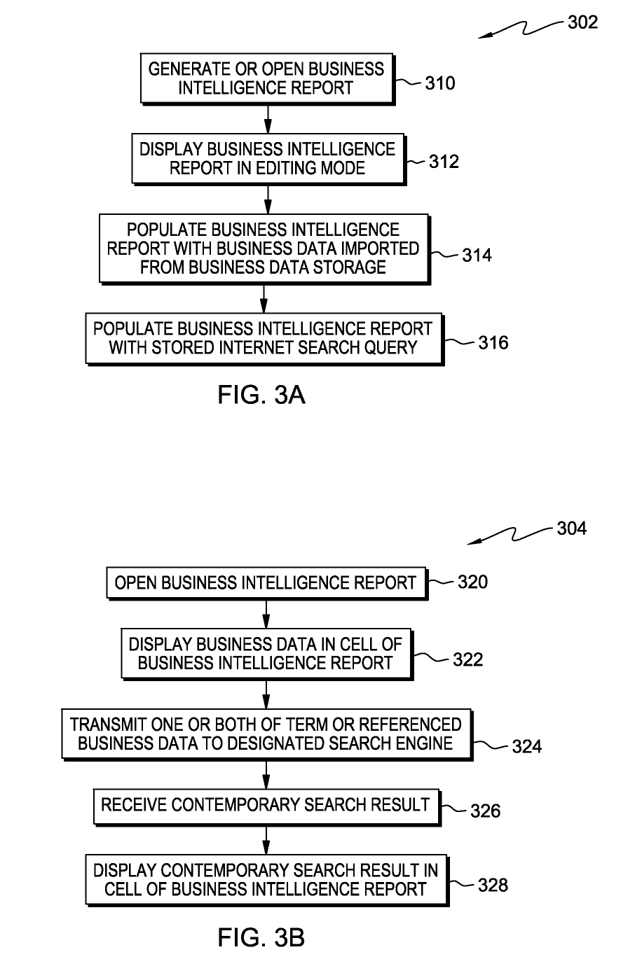

FIGS. 3A and 3B show flowcharts 302 and 304 depicting steps followed by report editor 132 and report viewer 134 during the editing and viewing of business intelligence report 140 in accordance with an embodiment of the present invention.

Referring now to FIG. 3A, flowchart 302 depicts steps followed by report editor 132 in accordance with an embodiment of the present invention. In step 310, report editor 132 generates or opens business intelligence report 140. In step 312, report editor 132 displays business intelligence report in editing mode on, for example, user interface 138. In step 314, report editor 132 populates business intelligence report 140 with business data 144 imported from business data storage 136. For example, in one embodiment report editor 132 imports business data 144 as a copy. In another embodiment, report editor 132 imports business data 144 as a link (for example, as a hyperlink, as an SQL query link, etc.), such that actual data can be retrieved from business data storage 136 during subsequent viewing (for example, not retrieved until step 322 discussed below, etc.). In step 316, report editor 132 populates business intelligence report 140 with stored internet search query 142. Search query 142 can include, in one embodiment, terms and links to business data 144 that will be used to perform a search during subsequent viewing of business intelligence report 140, as well as one or more designated search engines.

Referring now to FIG. 3B, flowchart 304 depicts steps followed by report viewer 134 in accordance with an embodiment of the present invention. In step 320, report viewer 134 opens business intelligence report 140. In step 322, report viewer 134 displays business data 144 in a cell of business intelligence report 140. For example, business data 144 can be displayed in one or both of data cell 252 and combined cell 256 of business intelligence report view 250. In step 324, report viewer 134 transmits one or both of a term of search query 142, or referenced business data of a link of search query 142, to a designated search engine of search query 142. The designated search engine can be included in query servers 120. In step 326, report viewer 134 receives a contemporary search result from the designated search engine. In step 328, report viewer 134 displays the contemporary search result in a cell of business intelligence report 140. For example, the contemporary search result can be displayed in one or both of query result cell 254 and combined cell 256 of business intelligence report view 250. The display of business intelligence report 140 is thus augmented with the contemporary search result.

Referring now to FIG. 4, a block diagram of a computer system in accordance with an embodiment of the present invention is shown. Computer system 400 is only one example of a suitable computer system and is not intended to suggest any limitation as to the scope of use or functionality of embodiments of the invention described herein. Regardless, computer system 400 is capable of being implemented and/or performing any of the functionality set forth hereinabove.

In computer system 400 there is computer 412, which is operational with numerous other general purpose or special purpose computing system environments or configurations. Examples of well-known computing systems, environments, and/or configurations that may be suitable for use with computer 412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each one of query servers 120, as well as computer 130, can include or can be implemented as an instance of computer 412.

Computer 412 may be described in the general context of computer system executable instructions, such as program modules, being executed by a computer system. Generally, program modules may include routines, programs, objects, components, logic, data structures, and so on that perform particular tasks or implement particular abstract data types. Computer 412 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 4, computer 412 in computer system 400 is shown in the form of a general-purpose computing device. The components of computer 412 may include, but are not limited to, one or more processors or processing units 416, memory 428, and bus 418 that couples various system components including memory 428 to processing unit 416.

Bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 412 typically includes a variety of computer system readable media. Such media may be any available media that is accessible by computer 412, and includes both volatile and non-volatile media, and removable and non-removable media.

Memory 428 can include computer system readable media in the form of volatile memory, such as random access memory (RAM) 430 and/or cache 432. Computer 412 may further include other removable/non-removable, volatile/non-volatile computer system storage media. By way of example only, storage system 434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 418 by one or more data media interfaces. As will be further depicted and described below, memory 428 may include at least one program product having a set (e.g., at least one) of program modules that are configured to carry out the functions of embodiments of the invention.

Program 440, having one or more program modules 442, may be stored in memory 428 by way of example, and not limitation, as well as an operating system, one or more application programs, other program modules, and program data. Each of the operating system, one or more application programs, other program modules, and program data or some combination thereof, may include an implementation of a networking environment. Program modules 442 generally carry out the functions and/or methodologies of embodiments of the invention as described herein. Report editor 132 and report viewer 134 can be implemented as or can be an instance of program 440.

Computer 412 may also communicate with one or more external devices 414 such as a keyboard, a pointing device, or one or more devices that enable a user to interact with computer 412, such as via user interface 138 on display 424; and/or any devices (e.g., network card, modem, etc.) that enable computer 412 to communicate with one or more other computing devices. Such communication can occur via Input/Output (I/O) interfaces 422. Still yet, computer 412 can communicate with one or more networks such as a local area network (LAN), a general wide area network (WAN), and/or a public network (e.g., the Internet) via network adapter 420. As depicted, network adapter 420 communicates with the other components of computer 412 via bus 418. It should be understood that although not shown, other hardware and/or software components could be used in conjunction with computer 412. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for augmenting a business intelligence report, the method comprising:
populating a business intelligence report with business data imported from business data storage, by at least one computing processor; and
populating the business intelligence report with a stored internet search query, by the at least one computing processor.

2. The method of claim 1, further comprising:
causing a display of the business data of the business intelligence report, by the at least one computing processor;
transmitting one or both of a term of the stored internet search query or of referenced business data of the stored internet search query to a designated search engine, by the at least one computing processor;
receiving a contemporary search result from the designated search engine, by the at least one computing processor; and
causing a display of the contemporary search result, by the at least one computing processor.

3. The method of claim 2, wherein the populating the business intelligence report with business data imported from business data storage includes including the business data in the business intelligence report as a copy, by the at least one computing processor.

4. The method of claim 2, wherein the designated search engine is included in the stored internet search query, by the at least one computing processor.

5. The method of claim 2, wherein the display of the business data of the business intelligence report includes a display of the business data in a cell of the business intelligence report, by the at least one computing processor.

6. The method of claim 2, wherein the display of the contemporary search result of the business intelligence report includes a display of the contemporary search result in a cell of the business intelligence report, by the at least one computing processor.

7. The method of claim 2, wherein the display of the business data of the business intelligence report and the display of the contemporary search result of the business intelligence report include a display of the business data and the contemporary search result in a cell of the business intelligence report, by the at least one computing processor.

8. The method of claim 6, wherein the display of the contemporary search result in a cell of the business intelligence report does not occur until a user interface event occurs, by the at least one computing processor.

9. A computer program product for augmenting a business intelligence report, the computer program product comprising:
one or more computer-readable tangible storage devices and program instructions stored on at least one of the one or more storage devices, the program instructions comprising:
program instructions to populate a business intelligence report with business data imported from business data storage; and
program instructions to populate the business intelligence report with a stored internet search query.

10. The computer program product of claim 9, further comprising:
program instructions to cause a display of the business data of the business intelligence report;
program instructions to transmit one or both of a term of the stored internet search query or of referenced business data of the stored internet search query to a designated search engine;
program instructions to receive a contemporary search result from the designated search engine; and
program instructions to cause a display of the contemporary search result.

11. The computer program product of claim 10, wherein populating the business intelligence report with business data imported from business data storage includes including the business data in the business intelligence report as a copy.

12. The computer program product of claim 10, wherein the designated search engine is included in the stored internet search query.

13. The computer program product of claim 10, wherein the display of the business data of the business intelligence report includes a display of the business data in a cell of the business intelligence report.

14. The computer program product of claim 10, wherein the display of the contemporary search result of the business intelligence report includes a display of the contemporary search result in a cell of the business intelligence report.

15. The computer program product of claim 14, wherein the display of the contemporary search result in a cell of the business intelligence report does not occur until a user interface event occurs.

16. A system for augmenting a business intelligence report, the system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to populate a business intelligence report with business data imported from business data storage; and
program instructions to populate the business intelligence report with a stored internet search query.

17. The system of claim 16, further comprising:
program instructions to cause a display of the business data of the business intelligence report;
program instructions to transmit one or both of a term of the stored internet search query or of referenced business data of the stored internet search query to a designated search engine;
program instructions to receive a contemporary search result from the designated search engine; and
program instructions to cause a display of the contemporary search result.

18. The system of claim 17, wherein populating the business intelligence report with business data imported from business data storage includes including the business data in the business intelligence report as a copy.

19. The system of claim 17, wherein the designated search engine is included in the stored internet search query.

20. The system of claim 17, wherein the display of the business data of the business intelligence report and the display of the contemporary search result of the business intelligence report include a display of the business data and the contemporary search result in a cell of the business intelligence report.
